(19) United States
(12) Patent Application Publication
(10) Pub. No.: US 2006/0169769 A1
(43) Pub. Date: Aug. 3, 2006

(54) Intelligent manager for automatically handling and managing media

(75) Inventors: Oleg Boyarsky, Cherry Hill, NJ (US); David Boyarsky, Cherry Hill, NJ (US)

Correspondence Address: DOCKET ADMINISTRATOR;LOWENSTEIN SANDLER PC, 65 LIVINGSTON AVENUE, ROSELAND, NJ, 07068, US

(73) Assignee: Leap-Up LLC

(21) Appl. No.: 11/328,646

(22) Filed: Jan. 10, 2006

Related U.S. Application Data
(60) Provisional application No. 60/649,199, filed on Feb. 2, 2005.

(51) Int. Cl. G06F 7/08

(52) U.S. Cl. 235/381

(57) ABSTRACT

A system for managing a plurality of media includes an apparatus that houses a subset of the plurality. The apparatus may dispense media, either in raw or packaged form, and may receive media in response to customer requests and transactions, by identifying and authenticating customers and media. The apparatus may be configured to operate alone or the apparatus may interface with a host circulation system and may connect to customer and media databases within the host circulation system to manage a plurality of media greater than the subset physically housed within. Additionally, the apparatus may be used as a self check-out station for items that are not housed within. The system maintains a transactional log and may provide a transactional receipt to each customer as well as accept payment as part of a customer transaction. Additionally, the system may include a remote servicing system to maintain the apparatus.

### CROSS REFERENCE TO RELATED APPLICATIONS

This application claims benefit of Provisional Application No. 60/649,199, filed on Feb. 2, 2005, entitled “Intelligent Manager for Automatically Handling and Managing Media Having a Plurality of Different Titles,” the entire disclosure of which is incorporated herein by reference.

### BACKGROUND OF THE INVENTION

1. Field of the Invention

The present invention relates generally to a system for managing media on which information is recorded. More particularly, the present invention relates to an apparatus for housing a plurality of media, dispensing a medium corresponding to a request, and receiving and housing a medium returned to the system so that the returned medium is available immediately for circulation.

2. Related Art

Presently, libraries and other establishments that handle numerous media or media collections typically require dedicated personnel to manage such media, by performing tasks such as handling customer requests for media, and reshelving the media to the proper locations when the media are returned by customers. For example, current neighborhood libraries circulate hundreds if not thousands of compact disks (“CD”) and digital video disks (“DVD”) (referred to herein as “media” for plural units or “medium” for a single unit) to customers bearing appropriate library cards or other forms of identification. The term “library” as used herein also refers to a storage facility and/or disaster recovery establishment, or the like, where archived and/or backup media is maintained. Additionally, the term “media” as used herein also refers to storage media on which information is recorded, including, but not limited, to CDs, DVDs, diskettes, books, flash memory units, game cartridges, video cassettes, and the like. Typically, a customer brings an empty medium container identifying a requested medium to a librarian. The librarian would retrieve the requested medium from a back room or other secure area where a plurality of media are shelved. The need for the library to hold its collection of media in a secure area stems from an effort to control the distribution of the actual media and to avoid theft by customers who do not go through the proper “check out” procedures before leaving the library with the media. Because of the popularity of the free circulation of media by libraries, a dedicated librarian often is required just to handle the day-to-day traffic of requests and returns. This adds to the costs of running libraries, which usually are funded by taxes. Also, returned media generally are not immediately available for recirculation, because they need to be “logged in” as having been returned, and they also need to be reshelved so that they may be found when requested in the future. This in turn results in a delay in the availability of some media, and ultimately a lower level of service to library customers.

Establishments that rent out media may follow a procedure similar to that discussed above for neighborhood libraries. Optionally, instead of storing its media collection in a secure area, an establishment may display the media on shelves, with each medium locked in its own container. A customer would bring a locked container housing a desired medium to a clerk, who unlocks the container when the customer presents proper identification and/or payment. The need for the establishment to lock its containers of media stems from an effort to avoid theft by customers who do not go through proper “check out” and payment procedures before leaving the establishment with the media. Therefore, the establishment by necessity has to employ one or more clerks to unlock containers, accept payment, and input customer rental information. Also, similar to neighborhood libraries, returned media generally are not immediately available for recirculation, because they need to be “logged in” as having been returned, and then they need to be reshelved so that customers know they are available for rental.

Accordingly, there is a need for a more efficient system to house and maintain media for circulation.

### SUMMARY OF THE INVENTION

According to an embodiment of the present invention, an apparatus, referred to herein as an Intelligent Media Manager or an IMM, is designed to house a large number of media in a secure environment, and manage media transactions, including dispensing the media to authenticated users in a “self check-out” mode of the IMM. Further, the IMM is designed to accept media from users and then automatically shelve or house the media within the apparatus for future checkouts, making the media immediately available. Optionally, the apparatus is designed to automatically accept payment and provide receipts for transactions.

The total number of media stored or housed in the IMM need not be fixed, but may vary. Additionally, the media housed in the IMM may vary and need not be the same from day to day, that is, each physical “slot” that houses a medium within the IMM need not be allocated for a specific medium title or medium type. Thus, the versatility of the IMM allows it to house multiple types of media at any one time, and provides for ease of loading and reloading the media housed within the IMM on a periodic basis. For example, through use of a “dynamic storage” feature, the IMM physically holds a predetermined maximum number of media but manages a greater number of media than what is physically held within. The phrase “dynamic storage” refers to the IMM's ability to manage a medium as long as the medium is defined in a host's (e.g., library's or retail establishment's) circulation system. That is, once information regarding a medium has been entered into the host's database, the IMM may determine whatever information it needs to properly track the medium without any staff (i.e., human) involvement by interfacing directly with the host's database. The dynamic storage feature of the IMM enables the host's collection of media to be far greater in number than the number of media that the IMM physically houses at any time. Accordingly, the IMM may track the media as they go through the circulation process.

According to an embodiment, the IMM also interfaces with the host's back-end database or circulation system (e.g., an Information and Library Services (ILS) system or other known database system) to authenticate a customer's validity, a medium's validity, and whether the customer and/or the medium is allowed to be processed for circulation based on previously defined policies of the host.

The IMM is designed to have a variety of modes for validating media and confirming that the validity of media that are checked in or returned are correct. These modes may include one or more of: (a) a barcode mode in which a barcode on a medium is read, regardless of the position or location of the barcode on the medium; (b) an RFID (radio-frequency identification) mode in which an RFID tag on a medium is read; (c) a content mode, where the tracks or content on a medium are used to validate the medium, and/or (d) an image mode in which a photographic image of a medium is taken and compared, upon-check in, automatically with a previously captured photographic image of the medium when it was checked out. Alternatively, the image mode may include displaying an image of the medium to a customer and receiving manual input from the customer as to whether the image matches the medium to be returned. Preferably, the IMM may incorporate one or more scanning devices to perform these functions, such as a dual mode IMM that scans and identifies both barcodes and RFID tags. The validation modes discussed herein are provided as examples, and one of ordinary skill in the art would easily understand that the IMM is not limited exclusively to one or more of those exemplary modes.

According to another aspect of the embodiment, the IMM identifies customers via, for example, identification cards or other objects bearing unique barcode identifiers or unique RFID tag identifiers, for example. Optionally, customers may be identified via unique alpha-numeric identifiers inputted to the IMM through, for example, a keyboard, a touch-screen display, a biometric device, or the like. The IMM associates a customer with a medium that is to be checked in or checked out by the customer by associating the customer's identifier with an identifier of the medium that is to be checked in or checked out. The selected medium is then dispensed directly to the customer, either in raw form, such as a CD alone without a jewel case, or in packaged form. Optionally, the IMM may be instructed to dispense a blank or empty medium container to a customer who wishes to return a medium and may have misplaced the original medium container.

Upon successful operation of the IMM by the customer, the customer may be presented with a printed receipt, which provides a written log of the customer's transaction(s). The information provided on the receipt may be defined by the host based upon the host's preferences. Additionally, the IMM may perform other transactions such as notifying a customer of late charges, notifications of library events, and retail transactions. The IMM's internal microprocessor manages and tracks which media of the host's collection are housed therein and which media have been checked out, including which customer or host personnel was last to use it through a transaction log, as well as its own status conditions necessary for its internal operation.

Preferably, the IMM interfaces with customers via a touch-screen display that guides the customers through the steps of operating the IMM via video, which may be animated and may include multi-lingual voice prompts. The animated display may have different screens targeted for particular types of customers. For example, an animated video may be shown to customers who are children, or a video in which the actor is of a particular ethnicity may be shown when a corresponding language is selected by a customer at the IMM. The display of the IMM includes a browser that allows the host to obtain and display information (e.g., the latest news, alerts, weather reports, etc.) from the Internet. The browser also may be used to point to the host's intranet for promotion of internal events or to display advertisements. In addition, the IMM's display may have a virtual bulletin-board area, which allows the host to display various messages of importance as they relate to the host's business. The contents of the virtual bulletin board may be remotely and dynamically managed by the host.

In yet another aspect of the embodiment, the IMM may be implemented as a single-bay kiosk, which is arranged to accommodate a single customer at a time. Alternately, an IMM may be designed as a multi-bay system, which is arranged to accommodate a plurality of customers at the same time. The multi-bay system includes a plurality of bays, each with its own display and/or its own media slot/bay.

Optionally, the IMM may be configured to be used as a display-only unit, in which media for circulation are not housed in the IMM but instead are kept external to the IMM. In this case, a customer uses the IMM to scan or read, for example, an empty container corresponding to a desired medium, or the customer views an inventory list of titles of media available for circulation on the IMM's touch-screen display, and makes a selection using the display. The customer then retrieves the selected medium from its location external to the IMM for the customer to pick up. The retrieval may be done manually by, for example, a librarian or a clerk, or the retrieval may be done automatically.

In the automatic retrieval scenario for an IMM as a display-only unit, multiple IMMs and/or a multi-bay IMM apparatus are operatively connected to a central media-housing apparatus. This allows multiple customers to browse the host's collection of media simultaneously without feeling pressured to make a quick selection so that another customer may use the IMM. When a customer makes a selection and goes through the check-out procedure of the IMM, the selected medium is automatically retrieved from the central media-housing apparatus commonly connected to the multiple IMMs and/or the multi-bay IMM. The selected medium is then dispensed directly to the customer, either in raw form, such as a CD alone without a jewel case, or in packaged form.

Alternately, the IMM may be configured to function in a “slave-only” mode, where the IMM acts as a receiving and dispensing unit only, such that the IMM may scan and/or receive an inquiry for a certain medium, but the host's circulation system manages customer authentication and validation, medium location and medium validation. In essence, the IMM is a “slave” to the host's circulation system and receives instructions from the host regarding customer and media transactions.

According to another aspect of the embodiment, dispensing includes the physical handling of the media, but also may include retrieving a medium in response to a request and inserting the medium into a connected external read/write device, such as a CD-ROM tower or jukebox. For example, libraries and other establishments often maintain voluminous references on CD-ROMs. Typically, a customer sends an email to a library personnel and requests that one or more CD-ROMs be inserted into an external CD-ROM jukebox. Once the library personnel inserts the CD-ROMs into the jukebox, the customer may then access the contents of the CD-ROM over the Internet. Using the IMM, a customer or patron may access a library's Website and enter a request to access certain sources that the library maintains on CD-ROM. Upon receiving this request, the IMM locates the CD-ROM responsive to the customer's request and inserts the CD-ROM into an external CD-ROM jukebox that the IMM is connected to, thus removing the need for library personnel to manually respond to the request. The IMM may then retrieve the CD-ROM from the CD-ROM jukebox once the customer has logged off the library's Website and rehouse the CD-ROM internally.

According to another aspect of the embodiment, the IMM may provide location information of a medium not housed within the media slots and/or not currently located within the immediate host location. For example, a library may have multiple branches. If a certain medium is located at a particular branch, the IMM may inform the customer of this information. Correspondingly, a customer may return a medium to an IMM at any branch associated with a particular library or host.

Optionally, the IMM may include a payment feature, in which the IMM functions to automatically request and accept payment for a medium. This allows the host to be able to charge per usage (e.g., when a medium is to be checked-out) and/or to charge a fee for late return of a medium. By linking a customer's identifier (from his/her identification card, for example) with the customer's circulation and/or payment records stored in the host's database(s), the IMM enables the host to prevent customers with unpaid fees, for example, above a predetermined amount, from being able to obtain additional media.

In yet another aspect of the embodiment, the IMM may include an administrative mode that is invoked via a special administrator's identification card or via a predetermined identifier inputted using the IMM's touch-screen display or keyboard. When in the administrative mode, the IMM allows the host's personnel to add/remove media housed therein, check inventory, and/or manage various other operational settings. According to one aspect of this embodiment, host personnel may use the IMM to write to or program an RFID tag placed on a medium that has yet to be written to or programmed. Thus, as the personnel is scanning barcodes on media using the IMM, the IMM also may detect an RFID tag on a medium that is “empty,” such that no information regarding the medium, the library, etc., has been written to the tag. The IMM then matches the empty RFID tag to the barcode previously scanned in to identify the medium, based on the information stored within either the host's circulation database or an internal media database maintained within the IMM. Upon achieving a successful match, the IMM writes the medium information, and any other necessary information, such as which library the medium is located, time and date stamp, etc., to the empty RFID tag. The IMM may also encrypt the RFID data as an option, and may optionally verify the programming of the RFID tag against a predefined set of programming rules.

According to another embodiment, as a patron is checking in or out a medium, an IMM may program an empty RFID tag simultaneously. For example, as a patron uses the IMM to scan a barcode on a CD during check-out, the IMM also scans an RFID tag attached to the CD and may detect that the RFID has yet to be programmed. Based on the identified barcode and matching information in the host's circulation database, the IMM programs the appropriate medium identification information to the CD and may encrypt. the information while the patron is in the process of checking out the CD. The RFID programming process is transparent to the patron, who is merely going through the check-out process. By programming the RFID tags as patrons check-in and check-out media, the IMM removes the requirement of having a host staff member program the RFID tags on all media, which typically requires a separate piece of costly hardware, and can be a labor intensive and error prone process.

The IMM may include a communication interface for communicating with a remote service system external to the host in order to monitor the operations of multiple IMMs from a central remote location. The service system may be, for example, at the location of the manufacturer of the IMM or at any other location of an IMM service technician. The technician, through the communication interface, can enable/disable the IMM, set up various options, perform troubleshooting operations, run usability reports, run diagnostics, and perform various other administrative functions from a remote location.

In the embodiment, the communication interface of the IMM allows the service technician not only to remotely gain access to the internal microprocessor of the IMM in order to determine the state of the IMM software, but also allows the technician to remotely cause internal elements of the IMM to move and to remotely turn on/off internal video capture devices, which enable the technician to see, in real time, internal mechanical elements (moving parts) of the IMM. This allows the technician to easily diagnose and correct any problem(s) with the IMM's operation.

Additionally, the remote monitoring capability may be used to allow host personnel to load media information into the IMM's internal database from a remote location, for example, from a central library office. Advantageously, the ability to monitor and manage multiple IMMs from a single location optimizes the efficiency of the IMM system and increases the efficiency of library operations.

In some embodiments of the present invention, while a customer is waiting for the IMM to process one or more transactions, the IMM display-screen may provide visual and audible information to the customer. This allows the host to provide “value-added” information to its customers, such as paid advertisements, trivia, general information and/or announcements about the host, public-interest announcements, advertisements about media available for circulation, movie previews, news, etc.

According to another embodiment of the present invention, in addition to providing an automated medium check-in and check-out process for customers, the IMM also may be used by customers to check out or check in other materials, such as books or audio cassettes, which typically are not housed within the IMM. For example, when installed in a library, the IMM allows a customer to request and automatically check out a desired DVD housed in the IMM as well as to routinely check out books by, for example, reading barcodes on the books. This allows the customer to perform a “one-stop” check-out process without the need to enlist the help of a librarian or the need to use different check-out stations to check out different types of media.

In yet another embodiment of the present invention, the IMM may be configured to function autonomously and without access to the host's database(s) in a “stand-alone” mode. In this mode, the IMM maintains its own customer and media databases, which enables the IMM to function independent of the host, including when the host's database(s) or circulation system may be malfunctioning. For example, in the master mode, the IMM authenticates a customer by reading and verifying the customer's identifier against the IMM's internal customer database. The identifier may be validated according to predefined rules, such as the number of digits, a number/letter pattern of alphanumerics, etc.

Using the stand-alone mode, the IMM may be used as a stand-alone kiosk or rental center. The IMM may be deployed at shopping malls, grocery stores, commuter stations, and other locations where people go with some regularity. Customers then have the convenience of, for example, renting a desired DVD at a bus/train station on the way home from work and returning the DVD the next morning on the way to work. Preferably, the IMM is connected to the Internet, so that maintenance and status checks may be performed remotely by a service technician.

According to another embodiment of the present invention, the IMM may be configured to “feed” external play-back devices, such as a CD/DVD players, MPEG devices, such as an iPod™, data recorders, game stations, on-line storage/backup devices, etc. That is, the IMM may dispense the tracks or contents of a medium, either in part of in full, into a play-back device to play back recorded content for a predetermined fee. Alternately, the IMM may be configured to load the contents of a medium onto a website, such as a host website, where a customer may access the contents for a certain amount of time in order to download the contents for a fee or as part of the host's service agreement with the customer. Alternately, the IMM may provide a preview of contents of a selected medium to a customer to aid in the selection of media by the customer for check-out or for retail purposes.

According to some embodiments, the media housed within an IMM may be loaded individually and the media information may be manually inputted into the IMM's internal database(s), either by host personnel or by a customer who is checking in a medium. Alternately, the media and media information may be loaded dynamically into the IMM in order to reduce the time and effort necessary to manually load each medium. Dynamic loading includes stacking the total number of media to be housed within the IMM into a physical loading component of the IMM at one time, in any order, and configuring the IMM to load each medium by (a) scanning a barcode, RFID tag, or some other medium identifier located on the medium, (b) validating the medium against either the host database or an internal IMM database, (c) allocating space within the IMM for the medium and physically placing the medium into a media slot or bay, and/or (d) updating either the internal IMM database or the host database of the success of the operation. The IMM continues this process for each medium until the entire stack is loaded. Once the load is completed, the IMM may generate a status report and may notify the host's circulation system of the completion.

Alternately, the media to be loaded may be stacked in a particular order and a list of the media order may be inputted into the IMM's database or may be retrieved from the host's database. During the validation of the medium, the IMM may scan the medium's identifier and verify the identifier against the uploaded list to verify that the medium is in the proper order. Thus, dynamic loading allows a host to load media into an IMM during off-hours, without requiring staff personnel to oversee the loading. In accordance with an aspect discussed above, the dynamic loading may be monitored from a remote location, for example, by host personnel through a host website, or by an IMM technician, who is prepared to react any problems during the dynamic load.

One or more IMMs may be networked together at a single location and may be configured to pass media from one IMM to another, thereby increasing the housing capacity of the media. Thus, a customer, accessing a first IMM and requesting a specific medium, may be dispensed the medium that is originally stored in another IMM, connected to the first IMM.

### BRIEF DESCRIPTION OF THE FIGURES

The advantages, nature and various additional features of the invention will appear more fully upon consideration of the illustrative embodiments now to be described in detail in connection with the accompanying drawings. In the drawings:

FIG. 1 illustrates a system incorporating an intelligent media manager apparatus, according to an embodiment of the present invention;

FIG. 2 is an illustration of a multi-bay intelligent media manager apparatus, according to an embodiment of the present invention;

FIG. 3 presents a method of use of an intelligent media manager apparatus, according to an embodiment of the present invention; and

FIG. 4 presents a method of programming medium identification tags using an intelligent media manager apparatus, according to an embodiment of the present invention.

### DETAILED DESCRIPTION OF THE INVENTION

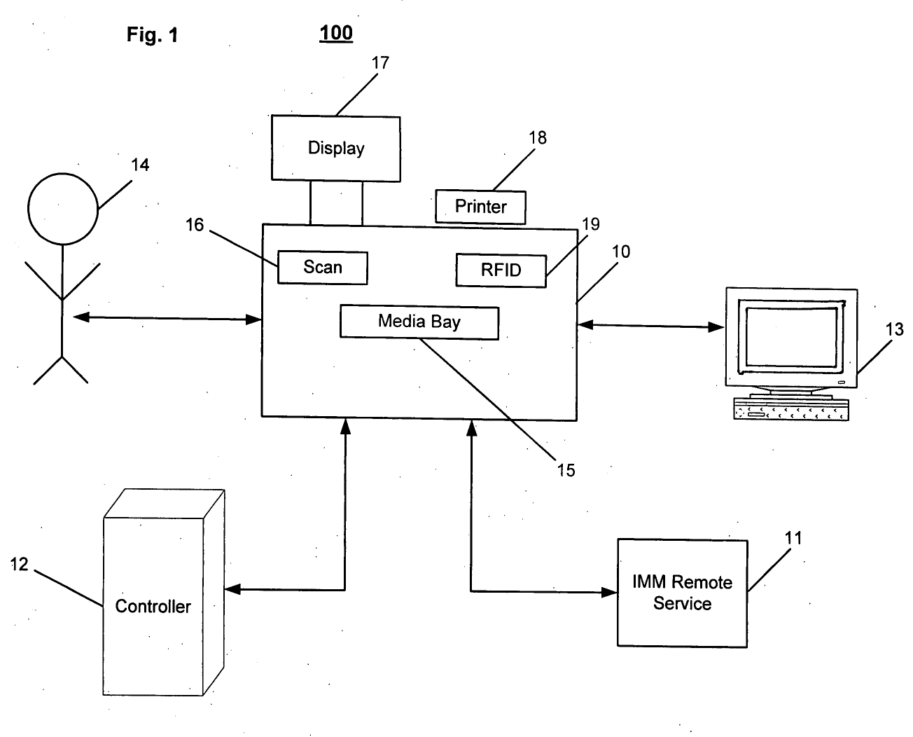

FIG. 1 schematically shows an arrangement of an IMM system 100 that incorporates an IMM 10, according to an embodiment of the present invention. The IMM 10 may house a plurality of media in an internal storage compartment. The IMM 10 includes a controller 12, which may reside within the IMM 10 or may be externally connected to the IMM 10. The controller 12 preferably is an application-specific controller. Optionally, the controller 12 is a standard microprocessor programmed to perform the control functions of the IMM 10 discussed herein.

As discussed above, the IMM 10 may function as a stand-alone unit. Optionally, the IMM 10 may be connected to a host system 13, such as a host's back-end database system. The host system 13 may include storage units storing one or more databases used by the IMM 10 to validate customer identifiers, to validate media to be checked in or checked out, to request/accept credit card payments or cash, and to provide rules to the IMM 10 to specify, for example, how long a medium may circulate before it must be returned, the categories of users that are permitted to check out various types of media, etc.

Optionally, the IMM 10 may be connected to a remote service location 11, so that the IMM 10 may be monitored and maintained by remote service technicians via, for example, the Internet or a dedicated telephone line.

A customer 14 may use the IMM 10 to, among other things, return (check-in) a borrowed medium, obtain (check-out) a requested medium, provide payment for a medium, and send queries to the IMM 10 regarding, for example, the number of copies of a desired medium currently in circulation. The IMM 10 may include a printer 18 to print a receipt for each transaction performed for the customer 14.

IMM 10 may include a scanning device 16 and a display 17, wherein the customer 14 may perform transactions on the display 17, and may scan his or her identification card using scanning device 16, as well as scan an empty medium case for item authentication and check-out) using scanning device 16. Media housed within IMM 10 is dispensed to the customer 14 via a media bay 15. The media bay 15 may also receive media being checked back into the system by customer 14. Although the IMM 10 in FIG. 1 is shown to have a single media dispensing bay 15, the IMM 10 instead may be a multi-bay system, which allows a plurality of customers 14 to view titles of media available for circulation, make selections, check in returned media, check out media, etc., in parallel.

The following is a list, in no particular order, of functions and functional units of the IMM 10:

Display 17—

The display 17 may be the primary, but not necessarily the only, means of communication between customer 14 and the IMM 10. Preferably, the display 17 is a touch-screen device that receives commands and other inputted information from the customer, and that provides audio and video information to the customer.

Media Bay 15—

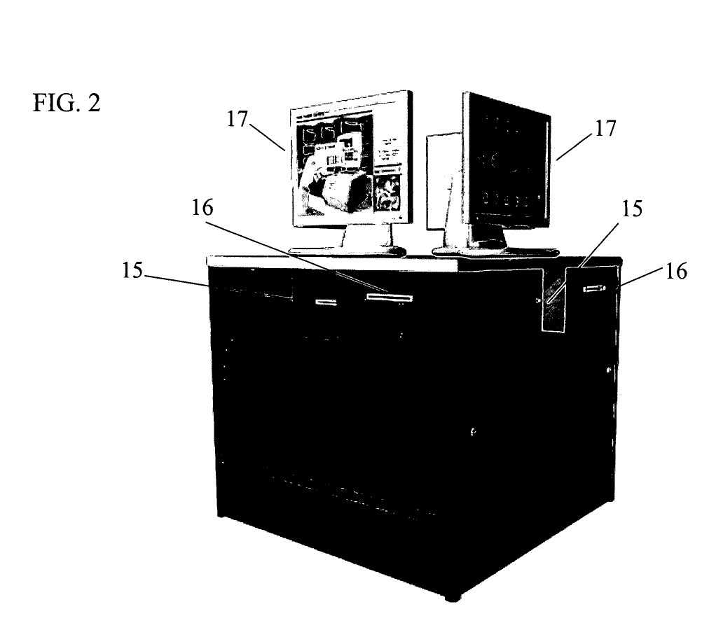

As shown in FIG. 2, the media bay 15 is a portion of the IMM 10 from which a requested medium is dispensed to a customer during a check-out process. The media bay 15 also functions to accept a medium returned to the IMM 10 during a check-in process.

Scanning Device 16—

The IMM 10 may include a scanning device 16 for reading customer identifiers, for example, from identification cards. For example, the scanning device 16 may read a barcode on a customer's identification card. Data included in the barcode is used by the IMM 10 to authenticate the customer. Authentication may include comparing the barcode data with information stored in a host's database(s), if the IMM 10 is connected to the host system 14, or comparing the barcode data with information internally stored in the IMM 10. The scanning device 16 also may be used to read control cards presented by host personnel to cause the IMM 10 to perform administrative control functions.

Additionally, the scanning device 16 may be used to read a medium identifier located on, for example, a container for a medium that customer 14 wants to check out. For example, the scanning device 16 may read a barcode on the medium container. Data included in the barcode is used by the IMM 10 to retrieve and dispense the desired medium to customer 14. Similarly, the scanning device 16 may be used to read an identifier, such as a barcode, on a medium being returned.

RFID Scanner 19—

Instead of, or in addition to, the scanning device 16, the IMM 10 may include an RFID scanner 19 for reading RFID tags on control cards, identification cards, and/or medium containers. Additionally, the RFID scanner 19 may be used to read RFID tags affixed to media. The RFID scanner 19 may also be a dual-mode scanner that reads and writes to RFID tags when the tag is empty.

Customer Authentication—

The IMM 10 may interface with and may be connected to (wirelessly or with wires) a host's back-end database system 13 to authenticate a customer 14 as well as to validate the customer's policy credentials as they relate to whether the customer is permitted check out or check in a medium. Alternatively, the IMM 10 may operate autonomously, independent of the host's back-end database system 13, and thus, may house a customer authentication database within.

Medium Authentication—

The IMM 10 may interface with and may be connected (wirelessly or with wires) to the host's back-end database system 13 to authenticate a medium in conjunction with the customer's policy credentials. That is, the IMM 10 determines whether a requested function for a medium (e.g., check in or check out) is permitted for a customer based on the host's policies with respect to that customer. For example, if, the customer is authenticated to be a child (i.e., under the age of 18 years), a medium authenticated to be a DVD for a movie that is rated for persons over the age of 18 years would not be permitted by the IMM 10 to be checked out by that customer. Alternatively, the IMM 10 may operate autonomously, independent of the host's back-end database system 13, and thus, may house a medium authentication database within.

Medium Validation—

The IMM 10 provides multiple levels of medium validation as a medium is being checked-in, i.e., the area of the IMM 10 that houses media available for circulation. These levels may include the ability to do any or all of: (a) read a barcode on a container holding a medium or on the actual medium itself, regardless of the barcode's position thereon; (b) read an identifying RFID tag affixed to the medium, (c) capture an image of the medium and compare the captured image either manually or automatically with a previously captured image of the medium when it was checked out. Although only three means of identification are disclosed, one of ordinary skill would recognize that the present invention is not limited to the above three means.

Printer 18—

The IMM 10 optionally includes a printer 18 for printing a receipt that describes a transaction. For example, after the customer 14 returns a medium to the media bay 15, and after the customer 14 and the medium are authenticated, the printer 18 prints a receipt indicating, for example, the title of the medium that was returned, the date of the return, and the customer's name. The printer 18 also may be used by the host to provide information to the customer 14. For example, when the customer 14 checks out a medium, the receipt may indicate the date that the medium must be returned to the host, the title of the medium, the customer's name, and the date the medium was checked out. In addition, the printer 18 may be used by the host as a revenue generating device by printing out coupons along with the standard receipts described above. The printer 18 may be any known type of printer, and may be integrated with the IMM 10 or a stand-alone unit that is connected (wirelessly or with wires) to and controlled by the IMM 10. Optionally, the printer 18 may include a function for printing RFID tags, photographic images, etc. as part of the medium validation process described above.

Wireless I/O—

The IMM 10 may be designed to have the option of connecting to the host's back-end database system through standard wires/cables or wirelessly by any known wireless protocol. For example, the IMM 10 may have a wired connection to the host's LAN using standard cables, or may have a wireless connection to the host's LAN using known wireless technology. Preferably, the IMM 10 is connected to the Internet via, for example, the 802.11a/b/g wireless protocol, which enables a service technician from the remote service location 11 to remotely assist in the installation and/or maintenance of the IMM 10 (using internal imaging devices and sensors) without having to travel to the location of the IMM 10. Additionally, software upgrades may be installed remotely by the service technician via this connection.

Imaging Device—

As discussed above, an imaging device may be used for the validation of media that are being checked in or checked out to/from the IMM 10, as well as for remote diagnostic evaluations in which a service technician remotely views images/video captured by the imaging device(s) to perform troubleshooting and maintenance. The imaging device also may be utilized for slot calibration and maintenance of the IMM 10. For example, the service technician may proxy (remotely take control of) the IMM 10 from the remote service location 11 and cause the electromechanical components of the IMM 10 to make physical adjustments based on images/video viewed remotely.

As shown in FIG. 2, an IMM 10 may have multiple patron stations. In FIG. 2, the IMM 10 has at least two displays 17, two scanning devices 16, and two media bays 15. This arrangement allows more than one patron 14 to utilize the IMM 10 at any time. Accordingly, the internal database of the IMM 10 may process multiple patron transactions at a time.

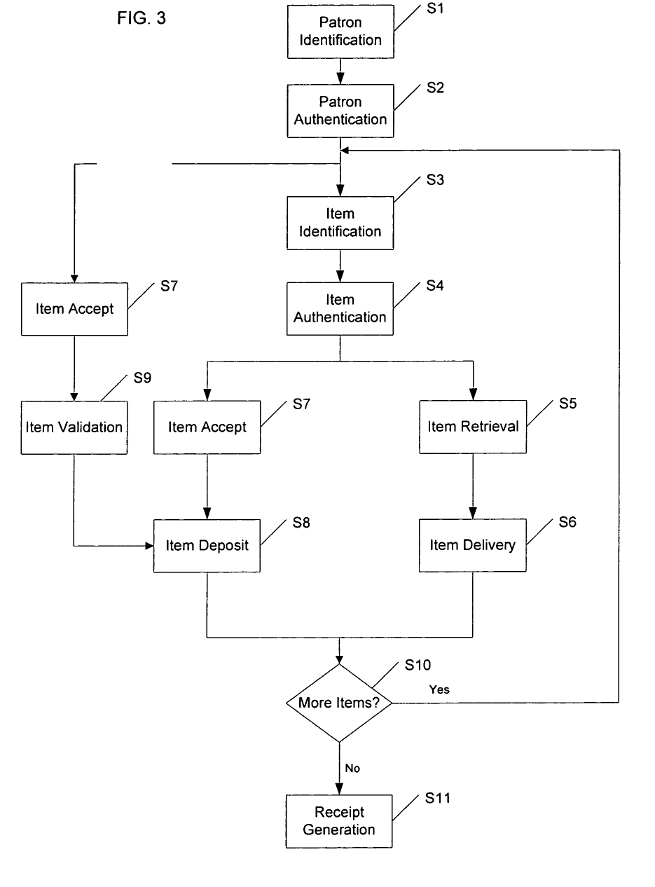

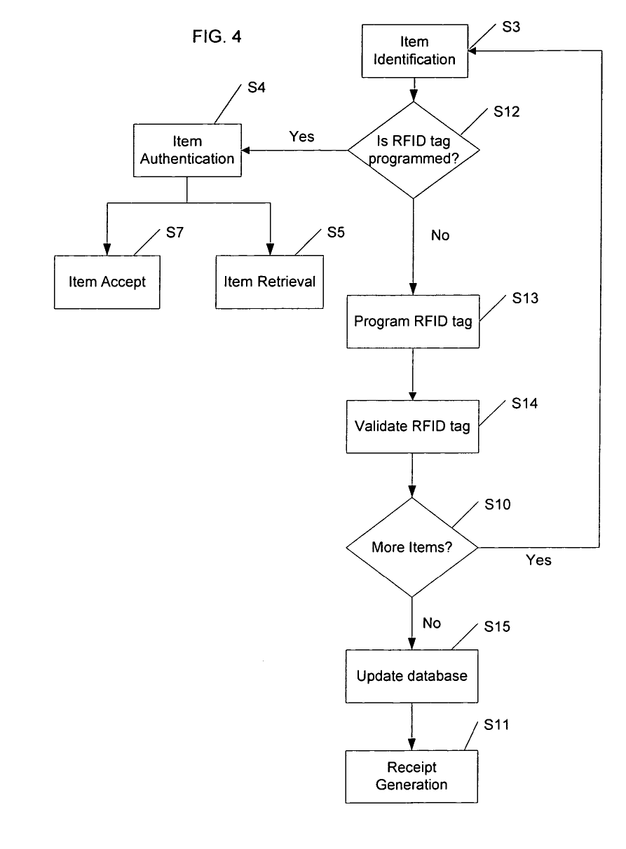

FIGS. 3 and 4 present methods of use of an IMM in accordance with embodiments of the present invention. The steps of each method need nor occur in the order presented, and some of the steps may occur essentially simultaneously. FIG. 3 presents a process flow of using an IMM 10, according to an embodiment of the present invention. In FIG. 3, a customer or patron 14 is identified, at step S1, using either the scanner 16, a touch-screen on the display 17, a keyboard, or some other means of accepting scanned or inputted information. Once the patron's information is acknowledged and processed, at step S2, the IMM 10 contacts the host's database to authenticate the inputted information, as well as to obtain the customer's credentials, which dictate the next course(s) of action for the IMM 10, such as go/no-go, account status information, etc. The IMM 10 also may update its internal transaction log and/or transaction and customer databases.

Once the IMM 10 has completed the patron authentication process satisfactorily, at step S3, an item or medium identification is requested by patron 14, for example, by using scanner 16 to scan an item container with an item identifier, such as a barcode, affixed. Optionally, the patron 14 may used the RFID scanner 19 to scan and read an affixed RFID tag in as a means of item identification. Alternately, the patron 14 may request a specific item by making a selection off the display 17. The IMM 10 queries the host's database 13 using the scanned barcode and/or RFID tag, or the display selection. At step S4, the IMM 10 queries the host's database 13 to authenticate the requested item, including, ascertaining the current status and location of the requested item, whether it is allowed to be processed as requested by the patron 14, and, coupled with the patron's information, whether the action requested by the patron 14 (e.g., check in or check out) complies with the host's existing policies. Assuming that the item authentication is successful, at step S5, the IMM 10 retrieves the item from the IMM's internal item-housing area (check-out mode), and delivers the requested item to the patron 14 via the media bay 15, at step S6. Accordingly, if the dispensed item is not retrieved by the patron 14 within a pre-determined amount of time from the media bay 15, the item is taken back inside the IMM 10, stored, and the item transaction is invalidated.

Optionally, if the patron 14 is requesting an item not housed within the IMM 10, the IMM 10 will provide the location of the requested item to the patron 14. Alternately, if the patron 14 is checking out an item already retrieved, such as, for example, a book or magazine, the IMM 10 also may serve as an automated check-out facility.

Alternately, the IMM 10 may perform steps S1 through S4 in response to a patron 14 who wishes to return an item. Upon successful patron authentication at step S2, the patron may use either the scanner 15 or the display 17 to identify the item to be returned. For example, patron 14 may use the scanner 15 to scan a barcode or some other identifying means on the item, at step S3. The IMM 10 then authenticates the item at step S4, and upon successful authentication, accepts the returned item from the patron 14, at step S7. At step S8, the IMM 10 deposits the item into a slot in the item-housing area of the IMM 10.

According to another option, the IMM 10 may perform steps S1 and S2 and then immediately accept an item into the media bay 15 placed by the patron 14, at step S7. The item validation includes determining whether the accepted item is a pre-defined item within the host's circulation system and whether the accepted item had been checked-out previously to the patron 14. Item validation may occur, for example, by scanning the contents of the item, by scanning an identifier barcode or RFID tag on the item, or by scanning an image of the item and comparing the scanned image to a previously captured image of the item. Once the accepted item has been verified, at step S8, the IMM 10 deposits the item into a slot within the item-housing area of the IMM 10.

Upon completion of the patron's transaction, the IMM 10 displays a request to the patron 14 as to whether there are more items to check-out or check-in, at step S10. If yes, the process flow repeats after the step of authenticating a patron (step S2). Alternately, the IMM 10 may be configured to repeat the process beginning with the step of authenticating the patron 14 (step S2) in prevent other patrons from using another patron's identification credentials to either check-in or check-out an item. If the patron 14 has completed all desired transactions, the IMM 10 may provide the patron 14 with a receipt of the patron's transactions, at step S11, using printer 18.

Throughout the steps of FIG. 3, the IMM's display 17 and the various patron-interaction controls (such as voice prompting, internal logs, report logs, remote automation controls, etc.) are updated as to the status and steps of the process flow. Thus, the display 17 and audio features of the IMM 10 may be used to provide the patron 14 the status of the patron's transactions in real-time. Additionally, the display 17 may be used as an advertising space to display ads, host information, notices, etc., while the patron 14 is using the IMM 10.

FIG. 4 presents a method of programming RFID tags using the IMM 10. As patron 14 begins to check in or check out an item, the patron 14 uses the scanner 16 to scan the barcode affixed to an empty item case to identify the item, at step S3. The IMM 10 identifies the item by querying the host's database 13 using the scanned barcode. Simultaneously, the RFID scanner 19 scans an RFID tag affixed to the item, and, at step S12, the IMM 10 determines whether the RFID tag has been programmed or is empty. If the RFID tag has been previously programmed, then, the process continues similarly to the process of FIG. 3, with the IMM 10 querying the host's database to authenticate the item, at step S4, and upon successful item authentication, the IMM 10 either retrieves the item for check-out, at step S5, or the IMM 10 accepts the item being checked in by patron 14, at step S7.

If the IMM 10 detects that the RFID tag scanned by RFID scanner 19 is empty, the IMM 10 begins to program the RFID tag, and may do so while the patron 14 is executing the item check-in or check-out process. Using the item identification information retrieved from the host database 13 in step S3, the IMM 10 writes the item identification information to the RFID tag at step S13, along with other process information, such as date and time, library branch identifier and information regarding the patron 14. Optionally, the RFID tag data may be encrypted for security purposes. Once the IMM 10 has completed programming the RFID tag, at step S14, the IMM 10 validates the RFID tag using a set of predefined rules to verify that the RFID tag was programmed properly and is functioning. Steps S13 through S14 may occur simultaneously with steps S4, S5, and S7, thus, the programming of the RFID tag is transparent to the patron 14 and does not hinder nor delay the patron's transactions.

At step S10, the IMM 10 displays a request to the patron 14 as to whether there are more items to check-out or check-in, and if so, the process repeats. If the patron 14 has completed the desired transactions, the IMM 10 then may update the host database 13 as well as an internal database of the transactions performed for the patron 14, at step S15, and generates a receipt of the patron's transactions for patron 14, at step S11, using printer 18.

While the present invention has been described with respect to what is presently considered to be the preferred embodiment(s), it is to be understood that the invention is not limited to the disclosed embodiment(s). To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An apparatus for managing media and media transactions comprising:
a storage compartment for housing a plurality of media;
at least one dispensing component for dispensing at least one medium of the plurality of media;
at least one receiving component for receiving at least one medium of the plurality of media;
an internal controller for executing program code stored in at least one memory, wherein the program code instructs the controller to:
house the plurality of media in an apparatus;
identify the at least one medium;
authenticate the at least one medium;
retrieve the at least one medium;
dispense the at least one medium;
accept the at least one medium from outside said apparatus; and
rehouse the at least one medium.

2. The apparatus of claim 1, further comprising a computer-readable memory, wherein the computer-readable memory comprises:
an internal customer database; and
an internal medium database.

3. The apparatus of claim 1, further comprising at least one scanning device and code for scanning a medium identifier and a customer identifier, wherein the medium identifier is one of: a barcode, a radio frequency identification tag, a medium image, or a manually entered alphanumeric identifier.

4. The apparatus of claim 3, wherein the code for scanning the at least one medium comprises detecting an empty medium identifier.

5. The apparatus of claim 4, further comprising code for writing information related to the at least one medium to the empty medium identifier.

6. The apparatus of claim 1, further comprising:
a keyboard; and
a display, wherein the display includes touch-screen technology.

7. The apparatus of claim 6, wherein the display is used to display at least one of: advertisements, status a media transaction, customer information, news, and contents of at least one medium.

8. The apparatus of claim 1, further comprising:
code for identifying a customer; and
code for authenticating a customer.

9. The apparatus of claim 1, further comprising:
a loading component for loading the plurality of media into the storage compartment, wherein the loading component is configured to load each medium of the plurality of media in accordance with a pre-determined order;
code for identifying each medium loaded; and
code for verifying that the loading of each medium is in compliance with the pre-determined order.

10. The apparatus of claim 1, further comprising:
a loading component for loading the plurality of media into the storage compartment in no pre-determined order;
code for identifying each medium loaded; and
code for inputting information related to each medium loaded into an internal media database.

11. The apparatus of claim 1, wherein the code for identifying the at least one medium comprises interpreting an inputted medium identifier, wherein the medium identifier is one of: a barcode, a radio frequency identification tag, a medium image, or a manually entered alphanumeric identifier.

12. The apparatus of claim 1, wherein the code for identifying the at least one medium comprises viewing the contents of the at least one medium and comparing the contents with stored information related to the at least one medium.

13. The apparatus of claim 1, further comprising a connection to at least one other apparatus, wherein the connection provides for transporting at least one medium between the apparatus and the at least one other apparatus.

14. The apparatus of claim 1, further comprising a connection to at least one external read/write device, wherein the connection provides for transporting at least one medium between the apparatus and the at least one external read/write device.

15. The apparatus of claim 14, wherein the at least one external read/write device is a CD-ROM jukebox.

16. The apparatus of claim 1, further comprising a module for accepting payment related to a media transaction.

17. The apparatus of claim 1, further comprising a printer to print at least one transactional receipt related to a media transaction.

18. The apparatus of claim 1, further comprising a connection to an external circulation system, wherein the circulation system comprises an external customer database and an internal customer database.

19. The apparatus of claim 1, further comprising a connection to a remote service system, wherein maintenance of the apparatus may be performed.

20. A method of managing media and media transactions comprising the steps of:
housing a plurality of media in an apparatus;
identifying the at least one medium;
authenticating the at least one medium;
retrieving the at least one medium;
dispensing the at least one medium;
accepting the at least one medium from outside said apparatus; and
rehousing the at least one medium.

21. The method of claim 20, wherein the step of identifying the at least one medium further comprises the step of receiving a request for the at least one medium.

22. The method of claim 21, wherein the step of receiving a request for the at least one medium comprises the step of scanning a medium identifier on a medium container, wherein the medium identifier is at least one of: a barcode, a radio frequency identification tag, and a medium image.

23. The apparatus of claim 22, wherein the step of scanning a medium identifier further comprises the step of detecting an empty medium identifier.

24. The apparatus of claim 23, further comprising the step of writing information related to the at least one medium to the empty medium identifier.

25. The method of claim 21, wherein the step of receiving a request for the at least one medium comprises receiving a manual input for the at least one medium.

26. The method of claim 20, wherein the step of authenticating the at least one medium further comprises the step of matching the received request to the at least one medium by searching a media database.

27. The method of claim 20, wherein the step of retrieving the at least one medium further comprises the step of retrieving the at least one medium from an area within the apparatus where the plurality of media is housed.

28. The method of claim 20, wherein the step of dispensing the at least one medium further comprises the step of ejecting the at least one medium through an opening in the apparatus, wherein the at least one medium is in raw form or in packaged form.

29. The method of claim 28, further comprising rehousing the at least one medium if it has not been removed from the opening after a predetermined amount of time.

30. The method of claim 20, wherein the step of accepting the at least one medium from outside said apparatus further comprises the step of sensing that the at least one media has been placed into an opening in the apparatus.

31. The method of claim 20, wherein the step of accepting the at least one medium from outside said apparatus further comprises the step of validating the accepted medium against information stored in a media database.

32. The method of claim 31, wherein the step of validating the accepted medium further comprises the step of comparing an identifier located on the accepted medium to information stored in the media database.

33. The method of claim 31, wherein the step of validating the accepted medium further comprises the step of comparing an image of the accepted medium to information stored in the media database.

34. The method of claim 20, wherein the step of rehousing the accepted medium further comprises the step of depositing the accepted medium into an area within the apparatus where the plurality of media is housed.

35. The method of claim 20, further comprising the steps of:
identifying a customer; and
authenticating a customer.

36. The method of claim 35, wherein the step of identifying a customer further comprises receiving a customer identifier wherein said step of receiving further comprises scanning a customer identifier, wherein the customer identifier is at least one of: a barcode, a radio frequency identification tag, and a biometric identifier.

37. The method of claim 36, wherein the step of receiving a customer identifier further comprises receiving the customer information manually inputted into the apparatus.

38. The method of claim 35, wherein the step of authenticating a customer comprises the steps of receiving a customer identifier and comparing the received customer identifier against information stored in a customer database.

39. The method of claim 38, further comprising the step of verifying that the customer related to the received customer identifier is authorized to receive the identified at least one medium.

40. The method of claim 20, further comprising the step of accepting payment in relation to dispensing the at least one medium.

41. The method of claim 20, further comprising generating a transactional receipt related to the at least one medium.

42. The method of claim 20, further comprising interacting with a remote service system, wherein the remote service system provides maintenance to the apparatus.

43. The method of claim 20, further comprising the step of loading the plurality of media into an area within the apparatus where the plurality of media is housed.

44. The method of claim 43, wherein the step of loading further comprises automatically loading each medium of the plurality of medium, and updating a media database contained within the apparatus.

45. The method of claim 44, wherein the step of automatically loading further comprises the step of loading in accordance with an ordered list of the plurality of media.

46. The method of claim 20, further comprising the step of displaying the status of the at least one medium.

47. The method of claim 20, further comprising interacting with a host circulation system, wherein the host circulation system comprises a media database and a customer database

48. The method of claim 20, further comprising the step of automatically uploading media information and customer information from the host circulation system.

49. The method of claim 20, further comprising the step of locating the at least one medium when it is not housed within the apparatus and providing the location.

50. The method of claim 20, further comprising the step of displaying at least one of the contents of the at least one medium.

51. The method of claim 20, further comprising the step of placing at least one of the contents of the at least one medium in a location for delivery.

52. The method of claim 20, further comprising the steps of:
identifying at least one item that is not housed within the apparatus; and
authenticating the at least one item.

53. A method of managing media and media transactions comprising the steps of:
housing a plurality of media in an apparatus;
receiving a request for at least one medium of the plurality of media;
receiving a first set of instructions from an external system regarding the at least one medium;
dispensing the at least one medium in response to the first set of instructions;
accepting the at least one medium from outside said apparatus;
receiving a second set of instructions from the external system regarding the at least one medium; and
rehousing the at least one medium in response to the second set of instructions.

54. A method for managing media and media transactions comprising the steps of:
housing a plurality of media in an apparatus;
identifying the at least one medium;
retrieving the at least one medium; and
dispensing the at least one medium in response to the first set of instructions.

55. A method for managing media and media transactions comprising the steps of:
accepting the at least one medium from outside said apparatus;
identifying the at least one medium;
authenticating the at least one medium; and
rehousing the at least one medium in response to the second set of instructions.

56. An apparatus for managing media and media transactions comprising:
a storage compartment for housing a plurality of media;
at least one dispensing component for dispensing at least one medium of the plurality of media;
at least one receiving component for receiving at least one medium of the plurality of media;
an internal controller for executing program code stored in at least one memory, wherein the program code instructs the controller to:
house a plurality of media in an apparatus;
identify the at least one medium;
retrieve the at least one medium; and
dispense the at least one medium.

57. An apparatus for managing media and media transactions comprising:
a storage compartment for housing a plurality of media;
at least one dispensing component for dispensing at least one medium of the plurality of media;
at least one receiving component for receiving at least one medium of the plurality of media;
an internal controller for executing program code stored in at least one memory, wherein the program code instructs the controller to:
accept the at least one medium from outside said apparatus;
identify the at least one medium;
authenticate the at least one medium; and
rehouse the at least one medium.

58. An apparatus for managing media and media transactions comprising:
a connection to a central media-housing apparatus, wherein the central media-housing apparatus houses a plurality of media, wherein the connection provides for transporting at least one medium of the plurality of media between the apparatus and the central media-housing apparatus;
at least one dispensing component for dispensing the at least one medium;
at least one receiving component for receiving at least one medium;
an internal controller for executing program code stored in at least one memory, wherein the program code instructs the controller to:
identify the at least one medium;
authenticate the at least one medium;
retrieve the at least one medium from the central media-housing apparatus;
dispense the at least one medium;
accept the at least one medium from outside said apparatus; and
return the at least one medium to the central media-housing apparatus.

59. A system for managing media and media transactions comprising:
at least one apparatus, wherein the apparatus houses a plurality of media and further comprises:
an internal customer database; and
an internal media database;
an internal controller for executing program code stored in at least one memory, wherein the program code instructs the controller to:
house a plurality of media in an apparatus;
identify the at least one medium;
authenticate the at least one medium;
retrieve the at least one medium;
dispense the at least one medium;
accept the at least one medium from outside said apparatus; and
rehouse the at least one medium;
a host circulation system connected to the at least one apparatus; and
a remote maintenance system connected to the at least one apparatus.

60. The system of claim 59, wherein the at least one apparatus is connected to a plurality of apparatuses.

61. The system of claim 59, wherein the host circulation system is wirelessly connected to the at least one apparatus.

62. The system of claim 59, wherein the remote maintenance system is wirelessly connected to the at least one apparatus.
